(19) United States
(12) Patent Application Publication
(10) Pub. No.: US 2017/0030588 A1
(43) Pub. Date: Feb. 2, 2017

(54) Air Permeable Oven Tray and Method of Use

(71) Applicant: Planit Products Ltd, Malvern (GB)

(72) Inventors: Guy Unwin, Cheltenham (GB); Caroline Kavanagh, Cheltenham (GB)

(21) Appl. No.: 14/809,555

(22) Filed: Jul. 27, 2015

(51) Int. Cl. F24C 15/16

(52) U.S. Cl. CPC F24C 15/16; A23L 1/0128; A23V 2002/00

(57) ABSTRACT

An oven tray formed from a sheet of glass fiber or other non-metallic temperature resistant mesh generally having a horizontal warp and weft, coated with a fluoropolymer such as PolyfTetraFluoroEthyleneor, silicone compound, etc. that provides a low friction coefficient coupled with high temperature resistance and light weight. The mesh is sufficiently widely spaced so an air gap exists between strands of weft and warp to allow circulation of air. The oven tray improved the quality of cooked food items in a variety of high temperature environments by increasing the ventilation afforded to the food item. The oven tray is both lightweight and has low thermal conductivity. In order to improve the rigidity of the material, the individual strands of mesh are aligned with the main axes of the tray.

The present invention relates to a food heating container made from a low friction flexible heatproof material permitting free circulation to all surfaces of the food items. In particular, the present invention relates to a food heating container which is made from low friction flexible heatproof materials permitting free air circulation and efficient heating to all surfaces of the food items.

### BACKGROUND OF THE INVENTION

Food items can be heated in either a conventional oven or in a microwave oven. However, it is desirable to provide a container that allows air to circulate freely while cooking food items, such as french fries and pizzas, and possesses low friction qualities for easy removal of the food item. Trays suitable for a microwave oven are not capable of withstanding the higher temperatures encountered in a conventional oven while trays designed for use in a conventional oven are not generally suitable for use in a microwave oven. Oven generally trays do not allow circulation of the air due to convection around all surfaces of the food item during cooking.

GB 0520391 (Unwin) discloses a tray for use in a conventional or microwave oven that is similar to the tray disclosed in WO2005/065457 (Turbochef) wherein such tray featured substantially vertical peripheral walls.

Other located prior art trays are illustrated in GB 1159021; U.S. Pat. No. 5,232,609; GB 2082939; FR 2505142; GB 2220346; IE S86331; JP H0646730; and GB 2466407.

### SUMMARY OF THE INVENTION

The present invention relates to a food heating container made from low friction flexible heatproof materials that permits free air circulation and efficient heating to all surfaces of the food items. The present invention permits improved circulation (which improves the quality of the heated food item) by increasing crispness all around the outer surface of the food item. French fries, pizzas and various food items can be cooked in conventional, circulating, radiating and microwave ovens using the invention with increased ease of handling and quality of the end result. The low thermal conductivity of the material used in the oven tray of the present invention gives an additional benefit due to the reduced chance of injury from burns caused by contact with the heated material. The oven tray of the present invention can also be used on a barbecue range or on a campfire, provided that care is taken not to expose the oven tray to direct flame for a prolonged period.

The oven tray of the present invention differs both in shape and construction from prior art oven trays. There are numerous food containers that hold food in an oven for cooking, but none of them have the desirable qualities of the present invention. The mesh used in the oven tray of the present invention is attached to a frame of metal, carbon fiber, polytetraflouroethylene (PTFE), silicone or other suitable heat-resistant material. Further, the dimension of the mesh strands is sufficiently large that the tray maintains adequate rigidity to retain the food item in the oven tray without additional support while being lifted. The material forming the oven tray of the present invention is generally a food grade glass fiber mesh which has a coating such as or PTFE or of one or a plurality of members of fluoropolymer family noted for their low friction characteristics. Alternatively, a coating of a member of the silicone family of plastics can be used. As can be appreciated, other types of fibers can be used (e.g., carbon fibers, aramid fibers, etc). The use of a PTFE on a mesh substrate is desirable as it allows a greater viewinv factor than molded forms of silicone. A further benefit of the present invention over existing baking trays and containers is its low thermal conductivity which allows for the removal of the container from the oven or other heat source without risking the burning of the hands.

One non-limiting method for using the oven tray of the present invention is as follows:

Placing the food item (e.g. potato fries, pizzas) into the oven tray;

Placing the oven tray into the heating means, oven or barbecue;

Heating the food item in the oven tray for the appropriate length of time;

Removing the oven tray from the heating means and;

Removing the food item from the oven tray by the most convenient means available with regard to the specific kitchen or food preparation area and;

Serving to the end user on a plate or other receptacle.

According to the present invention, there is a provided an oven tray formed from a sheet of glass fiber or other non-metallic temperature resistant mesh generally having a horizontal warp and vertical weft, coated with a fluoropolymer such as or PTFE, or a silicone compound providing a low friction coefficient coupled with high temperature resistance and light weight. The mesh should be sufficiently widely spaced that an air gap exists between the strands of weft and warp, in order to allow circulation of air. Experimentation has shown that the air flow over the food product greatly increases with an increased air gap and results is an improvement in heating a food item (e.g. fries, fish in batter, pizzas, rolls, toast, heated sandwiches, breaded chicken fingers) and other food items requiring a crisp outer surface. The oven tray of the present invention thus improves the quality of cooked food items in a variety of high temperature environments by increasing the ventilation afforded to the food item. The oven tray of the present invention is both lightweight and has low thermal conductivity. In order to optimise the rigidity of the material, the individual strands of the mesh are aligned with the main axes of the tray where possible. The size of the oven tray of the present invention can vary to suit a particular application, but generally will be of a size suitable for use in an oven.

To form the square or rectangular oven tray with shallow vertical mesh sides, a sheet of mesh material is defined and a notch or slit may be formed in the material at a certain number of interstices from each corner by cutting or removing a number of strands so that the flap thus formed can be rotated by 90 degrees and drawn inwards to overlap the adjacent side and form a double layer when brought together and conjoined, thus creating a 3-dimensional form. In this way, sections of mesh are defined to form a side for the tray. Once the corners are formed, the mesh material may provide a side with a gentle curvature from the center of the oven tray to the walls. The structure (when formed) can be held together in a number of ways, but typically attaches at the edges to a frame of metal, PTFE, or other suitable material which, in turn, is covered with a layer of silicone or similar substance to reduce heat transfer to the user. The frame is typically formed from a tubular rod or rods, rods, or strip of which ends may be welded or held together by a roll pin or pins or similar bisected tube forms and will be either square, rectangular or circular. Square or rectangular versions will generally have curved or rounded corners, although the method of construction can be to form sharp corners.

The oven tray of the present invention thus has a base and all or a majority of the side of the oven tray is formed from a layer of low-friction heat-resistant mesh material that is generally a flexible mesh. The oven tray includes a rigid or semi-rigid rim that is connected to the mesh material at the upper portion of the side of the oven tray.

The mesh material includes a fiber material (e.g., carbon fibers, aramid fibers, glass fibers, and/or other types of polymer fibers) that will not degrade at temperatures of at least 140° F., typically at least 180° F., more typically at least 250° F., and even more typically at least 300° F. In one non-limiting specific embodiment, the fibers are fully or partially glass fibers. The fiber material can be coated with one or more materials to facilitate in the heat resistivity of the fiber material (e.g., polyurethane, polytetrafluoroethylene, silicone, etc.) The coating material, when used, can also facilitate in inhibiting or preventing food items from sticking to and/or being absorbed in the fiber material. The coating material and/or fiber material can be a dark color (e.g., black) to facilitate in the absorption of heat so as to facilitate in the heating of food items in the food heating container.

The rim of the oven tray can be formed of a rigid or semi-rigid rod, strip or tube member that is connected to the mesh material (e.g., adhesive, stitching or tying, clamping, melted bond, friction connection, helical spring, etc.). The cross-sectional shape of the rod, strip or tube member can be circular, oval, polygonal or any other shape. The rod, strip or tube member can be formed of a single piece or multiple pieces of material. The rod, strip or tube member can be connected at its ends by any number of means (e.g., adhesive, melted bond, weld, etc.) or be moulded, stamped or otherwise formed by a solid single piece of material that is absent such connections. The material of the rod or tube member can be plastic, metal, carbon material, ceramic, composite material, polymer material, fiber material, silicone, etc. In one non-limiting arrangement, the material of the rod or tube member is a metal material. The rim also typically includes a cover or coating material over the rod, strip or tube member. One non-limiting material is a silicone compound; however, other materials can be used. Generally, the cover or coating material is a different material from the material used for the rod, strip or tube member. The cover or coating material can be a flexible material. The cover material can be connected to the rod, strip or tube member by any number of means (e.g., adhesive, clamping, melted bond, friction connection, etc.). The cover or coating material is generally made of a material that inhibits heat transfer so as to inhibit or prevent a user from burning one's hands when the user grasps the rim of the oven tray when removing the oven tray from the oven or microwave. The cover or coating material can be secured to the rod. strip or tube member by use of heat and/or pressure to mold the cover or coating material on to the rod, strip or tube member.

The mesh material can be attached by a variety of means to the rim such as, but not limited to, an adhesive means or by lacing a helical spring or springs around the rod, strip or tube member in such a way that each turn of the helical spring engages one strand of the mesh lattice and therefore binds the lattice to the frame. This method of attachment presumes that the material is cut squarely along the warp and weft of the material and forms a secure connection between the adjacent side that enables the formation of raised corners and thus creates the three-dimensional form of the tray. The spring, staple or helix which can be used will be of a similar pitch to the mesh size of the material and may be formed of any suitable material such as, but not limited to, stainless steel, carbon fiber, etc. At the corners of the rim, the spring may be augmented by others means such as additional springs, piece of metal wire, clamps, rivets etc. in order to gather the mesh to form the corner. The rim can have one full side length and two partial side lengths and at their ends be connected by means of the aforesaid roll pins, although it is envisaged that the rim can be formed of a single piece of material welded together or otherwise conjoined. The structure of the rim thus formed is ideally covered with a layer of a silicone compound which is adhered or molded around the completed the rod, strip or tube member and the region wherein the mesh is connected to the rod, strip or tube member frame. In one non-limiting specific arrangement, a tube of silicone that is slit or cut lengthwise in one place, is applied around the rod, strip or tube member and adhered thereto. The tube or layer may be formed from PTFE, or similar fluorpolymer material around the entire edge or by embedding the joined edges in a molten material such as silicone or forming a strip of molten material by the same effect. The same rim construction details apply to a circular formed rim, except that the circular formed rim may generally be formed without the addition of sides, and thus has a flat surface. Such a form may be applied to other geometric forms.

Other embodiments are envisaged such as a flat sheet of mesh as hereinbefore described at the edge of which is moulded or otherwise formed a side wall of silicone or PTFE, or similar such that the edge is roughly L-shaped with the possible addition of a rigid frame within said edge form. Said mesh could be held in place by rivets, wire or ‘poppers’ inserted through the holes in said edge form to engage the interstices of the mesh or be held in place by a heat pressure mold.

The oven tray of the present invention thus provides a means of effectively heating a range of food items without limiting the flow of air to the surface of the food item. When removing the oven tray from the heat source, it is rigid and stable and will support the weight of food item. It is also easy to handle with minimal protection against burn damage to the user.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 shows a perspective view of another non-limiting embodiment of the oven tray of the present invention;

FIG. 2 shows the invention in top plan view of the oven tray of FIG. 1;

FIG. 3 is a front elevation view of the oven tray along line A-A of FIG. 2; and,

FIG. 4 is a cross-section view along line A-A of FIG. 2.

### DETAILED DESCRIPTION OF NON-LIMITING EMBODIMENT

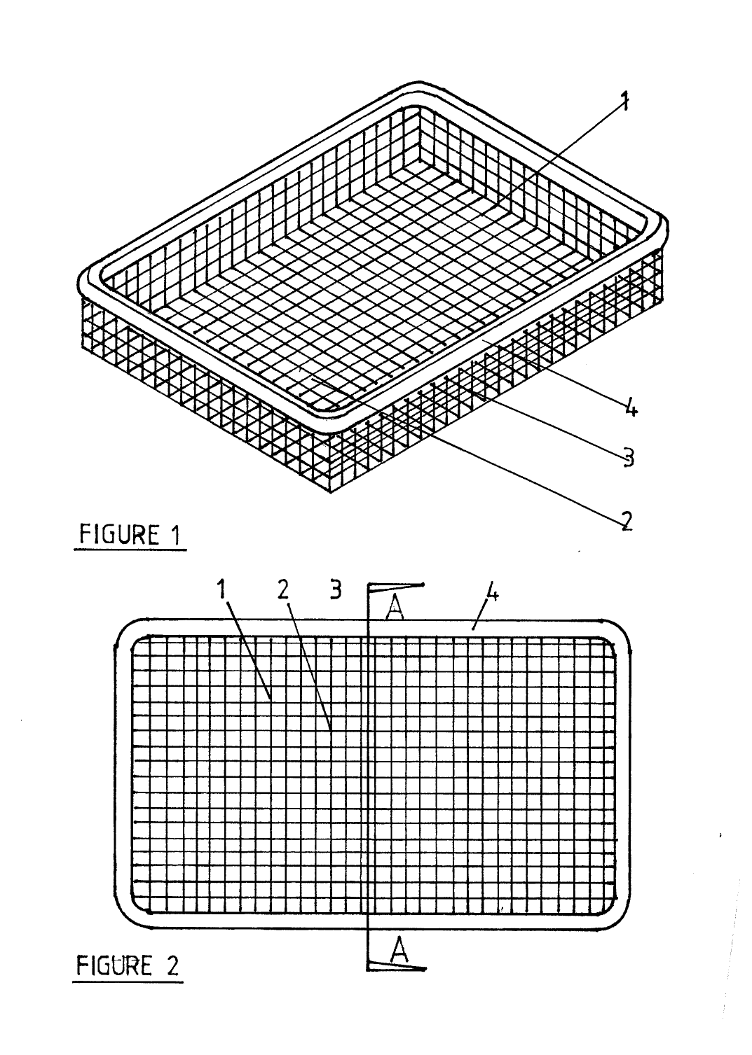

Referring now to the drawings wherein the showings are for the purpose of illustrating a non-limiting embodiment of the invention only and not for the purpose of limiting same, FIGS. 1-4 illustrate a non-limiting embodiment of the oven tray in accordance with the present invention.

Referring now to FIG. 1, there is illustrated an oven tray 1 that comprises mesh 2, side wall 3, silicone or other heat shield 4 and a metal frame 5. The edges of the sheet of mesh 2 are drawn together and overlapped at the corner thus forming a 3-dimensional corner section to the mesh 2 at all four corners. However, the corners may be formed by cutting and securing in place with wire and the frame and silicone edge rim are added and secured and formed together by heat pressure moulding. The side walls are thus formed. These side walls are then attached to a rigid former or formers namely frame 5 which may be of metal or some other rigid material such as carbon fibre or PTFE having corners that are curved or squared and being secured to its ends by welding or by means of a roll pin or pins or by heat pressure moulding. The frame 5 may be attached to the mesh 2 of the tray 1 by mean of adhesive and/or a helical spring or springs (not shown) that are wound onto the frame 5 in such a way so as to engage the mesh 2 of the side wall 3 by its interstices around the circumference of the frame 5. The frame 5 is then enveloped by a coating or a tube 4 of silicone or other similar material to provide thermal protection when heated. The frame 5 may also be attached and secured to mesh 2 of the tray and to the coating or a tube 4 of silicone or other similar material in a heat pressure mould.

Referring now to FIG. 2, the tray is formed of a sheet of mesh 2 made of PTFE or glass fiber. The frame in encased in a heat shield 4 in the form of a tube or strip of silicone or similar material, which has a slit on its inner side so that the mesh 2 can be inserted therein and held in place by adhesion, fusing or other known means, or the silicone tube forming the heat shield may be moulded into place around the circumference of the mesh 2.

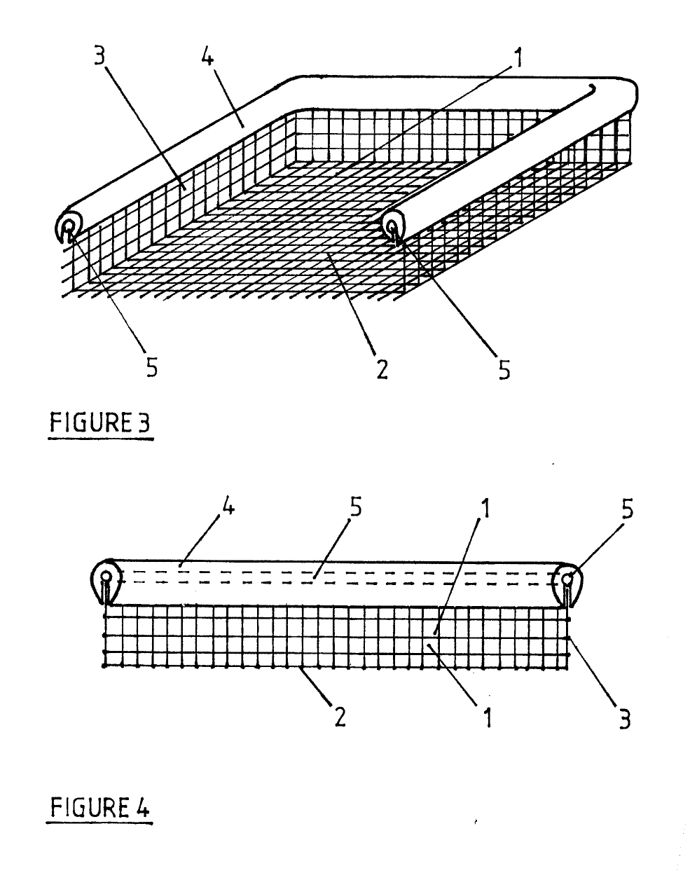

Referring now to FIG. 3, the mesh 2 is formed into a tray 1 and surmounted by a rigid frame 5 covered by a tube or strip of silicone or similar material which forms a heat shield 4. The weave of the mesh aligns vertically in such a manner that a spring of suitable pitch can be threaded helically through the gaps between warp and weft to form a corner. Additionally other methods of securing the assembly, such as heat pressure molding, may also be used to the same end and are not hereby excluded.

Referring now to FIG. 4, a section of the tray 1 shows the mesh sheet 2, side walls 3, and heat shield 4 surrounding the rigid frame 5. As before mentioned, the frame 5 may be held to the mesh 2 by a silicone tube or similar material by a variety of other means.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A tray for cooking food in a conventional or fan-assisted oven that operates by convectional heat transfer, said tray being formed from a sheet of flexible, temperature-resistant mesh of glass fiber coated with a non-stick material, having an air gap between the conjoined strands of weft and warp that allows free circulation of air so that food items are able to brown all over, together with a rigid frame surmounting said tray from, said mesh being aligned on the same axis as the basket itself.

2. A tray as claimed in claim 1, wherein said mesh tray is stabilized by a metal frame of one or a plurality of pieces adjacent to the top edge of the peripheral sidewall and then secured and covered by a silicone or similar strip, bead or trim around the entire top edge, said silicone strip being secure in place using silicone or similar adhesive or alternatively in a heat pressure mold.

3. A tray as claimed in claim 1, where the non-stick coating material is polytetrafluoroethylene or other member of the fluoropolymer family of thermally and electrically-inert materials.

4. A tray as claimed in claim 1, wherein the corners are held together by a continuous border or hem formed by applying fluoropolymer or silicone strip applied in solid or liquid form around the entire edge to form said border of hem.

5. A tray as claimed in claim 1, wherein the corners formed by folding the mesh material to created a 3-dimensional form are held together by the rigid frame and silicone covering, by a helical spring, piece of wire, rivet, clamp or clip to hold together a pair of adjacent strands of mesh at each corner.

6. A tray as claimed in claim 1, wherein the corners are held together by a helical spring rotated around individual strands of adjacent sections as herein described.

7. A tray as claimed in claim 1, wherein said rigid frame is incorporated into and held in place by said means and covered by a layer of silicone or fluoropolymer material with or without further means of adhesion.

8. A tray for cooking food in a conventional or fan-assisted oven, toaster oven or barbecue comprising an integral base and peripheral side walls formed of non-stick food grade mesh giving a high visibility factor, said walls being reinforced at their upper edge by a rigid frame of metal, carbon fiber or similar material applied to adjacent walls, said mesh being formed from a sheet of flexible, temperature resistant mesh of glass fiber aligned on the same axis as the tray, said mesh coated with a non-stick material, said mesh having a relatively large air gap between the conjoined strands of weft and warp that allows free circulation of air to heat the surface of the food items more evenly and efficiently and give a crisper finish; said rigid frame covered with a layer of silicone welded or otherwise secured in place.

9. A tray as claimed in claim 8, wherein the corners are held together by the rigid frame and silicone covering, or by applying a strip or layer of fluoropolymer or silicone across the corner seams and/or top edge and welding or otherwise adhering the mesh and the solid material.

10. A tray as claimed in claim 8, wherein the corners are held together by a continuous border or hem formed by applying a fluoropolymer or silicone strip in sold or liquid form to a rigid frame attached around the entire edge of the basket to form said hem and welding or otherwise adhering the frame, strip and mesh together.

11. A tray as claimed in claim 8, wherein the frame and body of the tray are held together by a continuous border, frame or hem formed by applying liquid silicone or strip or fluoropolymer to the upper edge of the mesh material to form a strip around the entire edge thus forming said border.

12. A tray as claimed in claim 8, wherein said tray is held together by a helical spring rotated around individual strands of the adjacent sections or mesh walls and the rigid frame so that the said frame is held in place as herein described.

13. A tray as claimed in claim 8, wherein the corners are held together by a clamp or clip holding together a pair of adjacent strands of mesh and the rigid frame at each corner, being generally arranged horizontally along a side or sides of the tray.

14. A tray as claimed in claim 8, wherein the corners are held together by the rigid frame and silicone covering, or by one or a plurality of rivets, eyelets or rivet-like pop connectors holding together a pair of adjacent strands of mesh at each corner.

15. A tray as claimed in claim 8, wherein the frame, the silicone strip or fluoropolymer and the body of the tray are held together by heat pressure molding.

16. The method of cooking using the present invention comprising the steps of:
Placing the food item (e.g. french fries, southern fried chicken, pizza, fish in batter etc.) into the tray, said tray being formed from a sheet of flexible, temperature-resistant mesh of glass fiber coated with a non-stick material, having an air gap between the conjoined strands of weft and warp that allows free circulation of air so that food items are able to brown all over, together with a rigid frame surmounting said tray from, said mesh being aligned on the same axis as the basket itself;
Placing the tray into the heating appliance or environment (e.g. oven, open fire or barbecue) applying heat thereto for the appropriate length of time until the food item is cooked and;
Removing the food item from the basket by conventional means.
